(19) United States
(12) Patent Application Publication
(10) Pub. No.: US 2008/0289771 A1
(43) Pub. Date: Nov. 27, 2008

(54) Label removing tool

(76) Inventor: Jocelyn Lauzon, Laplaine (CA)

Correspondence Address: INVENTARIUM;SUITE 1607, 4050 ROSEMONT, MONTREAL, QC, H1X 1M4, CA

(21) Appl. No.: 12/125,029

(22) Filed: May 21, 2008

Related U.S. Application Data
(60) Provisional application No. 60/931,104, filed on May 21, 2007.

(51) Int. Cl. B32B 38/10

(52) U.S. Cl. 156/584

(57) ABSTRACT

A label removing tool has a blade located externally from the structural body. a blade moving means to angularly change, in relation to a rotational axis, the position of a blade holding block. The blade is dependent of the motion of the block by way of being attached to the block. The blade moves in both an angular displacement and a lateral shift from being off the rotational axis.

This application claims priority based on provisional application 60/931,104 filed May 21, 2008

### FIELD OF THE INVENTION

The present invention relates generally to scrapers but more particularly to a scraper that removes old label and other such painted and glued on signage.

### BACKGROUND OF THE INVENTION

Logos, labeling and various signage are often painted but more often applied on various objects by way of glued on-vinyl sheeting material. These signs are glued on various surfaces including vehicles. Sometimes, those signs have to be removed, which involves a very tedious and time consuming operation. Electric or air powered scrapers currently in use are inadequate for this specific use.

### SUMMARY OF THE INVENTION

In view of the foregoing disadvantages inherent in the known devices now present in the prior art, the present invention, which will be described subsequently in greater detail, is to provide objects and advantages which are:

To provide for an quick, efficient and effortless way of removing labels and all manners of sheeting material adhered to a surface.

To attain these ends, the present invention generally comprises a blade located externally from the structural body. a blade moving means to angularly change, in relation to a rotational axis, the position of a blade holding block. The blade is dependent of the motion of the block by way of being attached to the block. The blade moves in both an angular displacement and a lateral shift from being off the rotational axis.

In a preferred embodiment, the blade moving means is in the form of a main shaft which connects a gear box to a peg holder. A shaft extends integrally from a rotational motive means. A peg extends perpendicularly from the peg holder and is positioned inside of a channel. the translational motion of the peg within the channel forces angular changes in the positioning of the block in relation to the rotational axis.

Preferably, the gear box contains a variety of gears to reduce revolutions per minutes of the main shaft in relation to the revolutions per minutes of a shaft. Also, the blade is removably attached to the block.

The label removing tool has a method of use consisting in the steps of having a user powers up the label removing tool; present it onto a label to be removed by having the blade in motion and engaging it onto the label to be removed; gliding the label removing tool over the surface onto which the label is adhered to and having the blade attack the label from underneath so as to peel off the label.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the device.

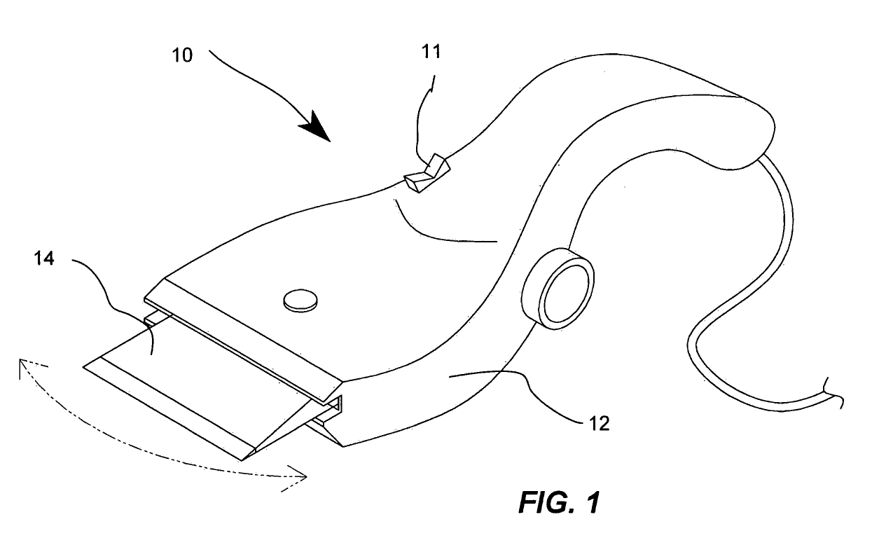

FIG. 2 Isometric view of the inside of the device.

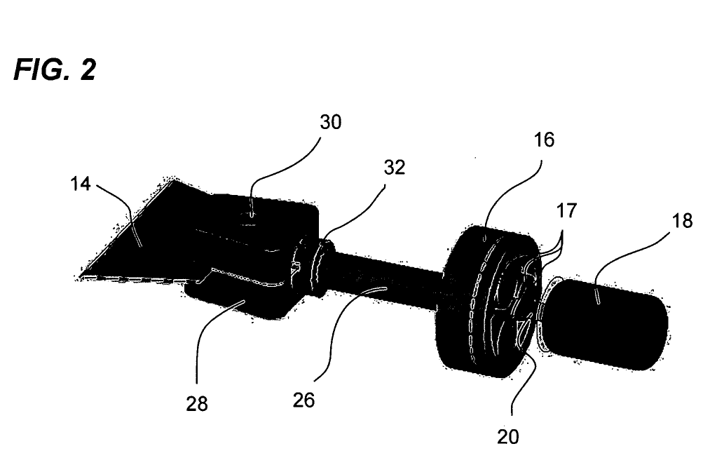

FIGS. 3a-c Top views of the device showing 3 positions of the blade.

FIGS. 4a-d front schematic views along line AA showing 4 positions of the peg within the channel.

### DETAILED DESCRIPTION

A label removing tool (10) has a structural body (12) with a blade (14) being located outside of that structural body (12). In order to accomplish the variable angle of attack of the blade (14), a blade moving means is used and has for function to angularly change, in relation to a rotational axis (30), the position of a blade holding block (28). The blade (14), which is releasably attached to the block (28), is dependent of the motion of the block (28) but, being off the axis (30) has both an angular displacement and a lateral shift.

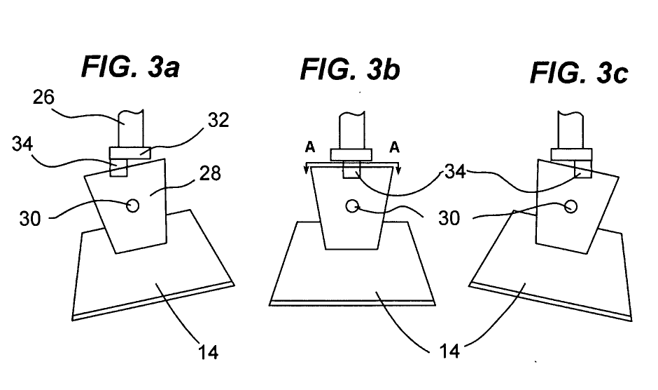

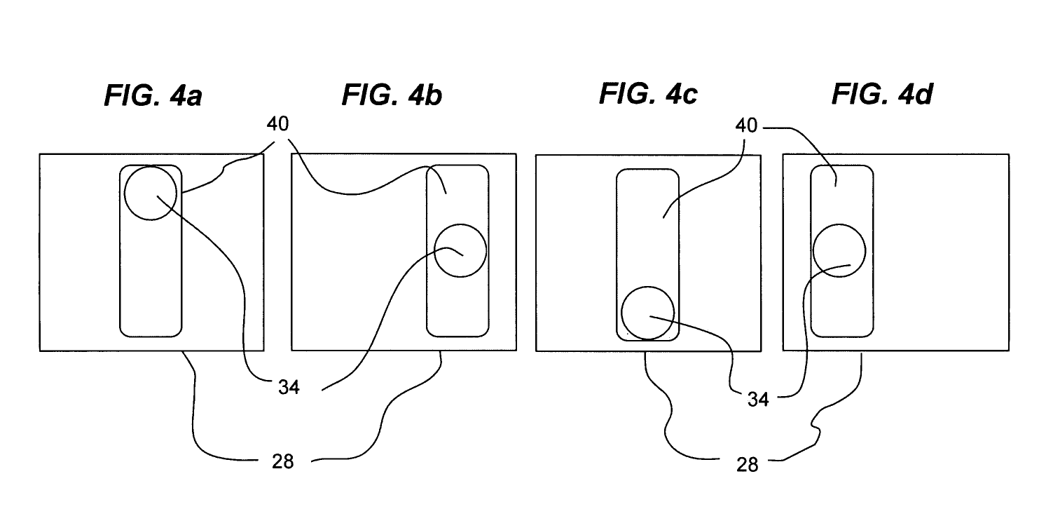

In a preferred embodiment, the blade moving means is in the form of a main shaft (26) which connects a gear box (16) to a peg holder (32). The gear box (16) contains a variety of gears (17) to reduce revolutions per minutes of the main shaft (26) in relation to the revolutions per minutes of a shaft (20). The workings of the gear box (16) is well known in the art and need not be further discussed. Let's also add that the advantage of reducing revolutions per minutes is that it also adds torque to the main shaft (26). The shaft (20) extends integrally from a rotational motive means (18). Any type of rotational motive means can be used such as, for example, an electric motor, a hydraulic motor or a pneumatic motor. Going back to the peg holder (32), as seen FIGS. 4a-d, a peg (34) extends perpendicularly from the peg holder (32) and is positioned inside of a channel (40). FIG. 4b and FIG. 4D represent FIG. 3A and FIG. 3C, respectively, as per the position of the peg (34). FIG. 4A and FIG. 4C would represent FIG. 3B as far as the peg (34) position is concerned. This is how the rotational motion of the main shaft (26) is transformed into the angular displacement and lateral shift of the blade (14). The channel (40) can be shaped differently such as oval so as to better interact with the movement of the peg (34) within it.

In cooperation, the hereinabove parts induce a unique motion of the blade (14) which constantly varies its angle of attack so that it presents alternating diagonal angles of attack that provide for a better removal action.

In operation, a user powers up the label removing tool (10) by turning on a switch (11) and presenting the label removing tool (10) onto a label to be removed (not shown) by having the blade (14) in motion and engaging it onto the label to be removed. Gliding the label removing tool (10) over the surface onto which the label is adhered to and having the blade attack the sign from underneath, that is between the surface it is adhered to and the adhering side of the label, makes the blade, aided by its unique motion peel off the label. The term label used hereinabove is of course to be interpreted as a catch all word to describe any type of signage or sheeting material generally adhered to a surface.

The blade (14) is preferably removably attached to the block (28) so that it can be changed as it wears down. Again, the particulars of attachment means of blades is well known in various art and need not be further discussed here.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A label removing tool having a structural body and comprising:
a blade located externally from the structural body;
a blade moving means to angularly change, in relation to a rotational axis, the position of a blade holding block;
the blade is dependent of the motion of the block by way of being attached to the block;
the blade moves in both an angular displacement and a lateral shift from being off the rotational axis.

2. A label removing tool as in claim 1 wherein:
the blade moving means is in the form of a main shaft which connects a gear box to a peg holder;
a shaft extends integrally from a rotational motive means;
a peg extends perpendicularly from the peg holder and is positioned inside of a channel;
the translational motion of the peg within the channel forces angular changes in the positioning of the block in relation to the rotational axis.

3. A label removing tool as in claim 2 wherein:
the gear box contains a variety of gears to reduce revolutions per minutes of the main shaft in relation to the revolutions per minutes of a shaft.

4. A label removing tool as in claim 2 wherein:
the blade is removably attached to the block.

5. A label removing tool as in claim 1 having a method of use consisting in the steps of:
a user powers up the label removing tool;
presents it onto a label to be removed by having the blade in motion and engaging it onto the label to be removed;
gliding the label removing tool over the surface onto which the label is adhered to and having the blade attack the label from underneath so as to peel off the label.
